(19) United States
(12) Patent Application Publication
(10) Pub. No.: US 2008/0284351 A1
(43) Pub. Date: Nov. 20, 2008

(54) Ignition Module for Gas Discharge Lamp

(75) Inventors: Shiguang Sun, Shanghai (CN); Chuncheng Jiang, Shanghai (CN); Xin Liu, Shanghai (CN)

Correspondence Address: PHILIPS INTELLECTUAL PROPERTY & STANDARDS, PO BOX 3001, BRIARCLIFF MANOR, NY, 10510-8001, US

(73) Assignee: KONINKLIJKE PHILIPS ELECTRONICS N.V., EINDHOVEN (NL)

(21) Appl. No.: 12/092,240

(22) PCT Filed: Oct. 27, 2006
(86) PCT No.: PCT/IB06/53954

§ 371 Date: Apr. 30, 2008

(30) Foreign Application Priority Data
Jul. 10, 2007 (CN) 200510118571.6

(51) Int. Cl. H05B 37/02

(52) U.S. Cl. 315/291

(57) ABSTRACT

The present invention relates to an ignition module for a gas discharge lamp, said ignition module comprising: a first module for generating a first series of pulse from a low frequency driving signal, a second module for generating a second series of pulse from a high frequency driving signal, and a superposing and boosting module for boosting module for superposing and increasing said first series of pulse and said second series of pulse so as to generate an output pulse intended to break down the gas in said gas discharge lamp. Via this invention, a high effective OCV can be easily obtained without increasing the DCBUS, and the ignition of the gas discharge lamp is improved.

### FILED OF THE INVENTION

The present invention relates to an ignition module for gas discharge, in particular to an ignition module for a ballast of high intensity discharge (HID) lamp.

### BACKGROUND OF THE INVENTION

The ignition of high intensity discharge (HID) lamp requires not only to produce instantaneous high voltage pulse ignition voltage at the two ends of the arc tube, but also to provide an open circuit voltage (OCV) with relatively high effective value so as to supply enough energy to convert the glow discharge into arc discharge as soon as possible thereby to finish the ignition process. The circuit structure of the conventional electronic ballast usually includes the rectification and power factor correction circuit part for transferring mains alternate current to direct current (AC-DC), the inverter circuit part for transferring direct current to alternate current (DC-AC) and the ignition circuit part (Ignitor). By means of the rectification and power factor correction circuit part (AC-DC), the mains alternate voltage is transformed into direct current bus (DCBUS) voltage; by means of the inverter circuit part (DC-AC), the direct current bus voltage is transformed into alternating voltage again and outputs open circuit voltage (OCV) having a certain effective value; by means of the ignition circuit part, high voltage pulse with high amplitude is generated at the two ends of the arc tube so as to break down the arc tube.

At present, the inverter circuit of half-bridge topology structure has been widely used because of its low cost. In such topology structure, the obtained effective value of the OCV is only half of the DCBUS voltage. For example, the usual electronic ballast DCBUS voltage is 400V, thus the obtained effective value of the open circuit voltage can only reach 200V. However, the OCV generally required for ignition of the high intensity discharge lamp may be higher than half of the DCBUS voltage, e.g., 250V, or preferably, 280-300V. To solve this problem, people usually increase the DCBUS voltage so as to obtain a higher OCV; for example, increase the DCBUS to 500V or 560V so as to obtain an OCV of 250V-280V, whereby the need of ignition is met.

FIG. 1 is a a known block diagram of ignition of a known high intensity discharge lamp. By means of the usual rectification and power factor correction circuit (AC-DC), the utility power voltage of 220V, 50Hz can be expediently transformed into the voltage with the DCBUS of 400V. Therefore, in order to obtain the signal output of the DCBUS with higher voltage, such as 560V, the corresponding boost convertor module (BCM) is needed. On the basis of this, the inverter circuit (DC-AC), such as the usual half-bridge inverter circuit, can be used to obtain the voltage V1 whose effective value is half of the DCBUS effective value, e.g., an open circuit voltage (OCV) of 280V, to supply energy for ignition the gas discharge lamp. Meanwhile, during the ignition stage, the ignition circuit (Ignitor, shown as “I” in FIG. 1) generates a narrow and high voltage pulse V2 at the two ends of the gas discharge lamp so as to break down the gas in the arc tube of the high intensity discharge lamp, thus finally to start said high intensity discharge lamp under certain open circuit voltage condition. Consequently, the OCV formed at the two ends of the lamp is V3, whose effective value is substantially the same as or slightly higher than that of V1.

In above-mentioned ignition mode, since the DCBUS voltage is boosted, the complexity of the circuit is increased; meanwhile, much higher requirements are made to the performance parameters of the electric elements of the whole circuit. For example, the electrolytic capacitor requires higher voltage withstand parameter or switch element with higher breakdown voltage. Thus, the total cost for the ballast will be prominently increased.

### SUMMERY OF THE INVENTION

It is an object of the present invention to propose a new device and method for obtaining high effective OCV without notably increasing the cost, specifically, without changing the topology structure of the current electronic ballast and increasing the DCBUS voltage.

To this end, the present invention proposes an ignition module for a gas discharge lamp, said ignition module comprising:
a first module for generating a first series of pulse from a low frequency driving signal,
a second module for generating a second series of pulse from a high frequency driving signal,
a superposing and boosting module for boosting module for superposing and increasing said first series of pulse and said second series of pulse so as to generate an output pulse intended to break down the gas in said gas discharge lamp.

According to another aspect of the invention, the present invention proposes a system for starting a gas discharge lamp, said system comprising:
a rectifier for transforming an AC mains voltage into a DC voltage,
an inverter for transforming said DC voltage into a first AC voltage intended to provide energy to said gas discharge lamp,
a first module for generating a first series of pulse from a low frequency driving signal,
a second module for generating a second series of pulse from a high frequency driving signal,
a superposing and boosting module for superposing and boosting said first series of pulse and said second series of pulse so as to generate an output pulse intended to break down the gas in the gas discharge lamp.

According to another aspect of the invention, the present invention proposes a ballast of gas discharge lamp, which comprises above-mentioned ignition module or system.

According to another aspect of the invention, the present invention proposes a method of starting a gas discharge lamp, said method comprising the steps of:
generating a first series of pulse from a low frequency driving signal,
generating a second series of pulse from a high frequency driving signal,
superposing and boosting said second series of pulse so as to generate an output pulse intended to break down the gas in said gas discharge lamp.

By the enforcement of the present invention, the gas discharge lamp will only require a lower DCBUS voltage for starting the lamp effectively. Thus, on the one hand, during the rectification stage (AC-DC), the boosting unit can be bypassed; on the other hand, because of the low level of the DCBUS voltage, many electronic units do not require strict parameters, i.e. some low capability units, such as capacitors or switches with low breakdown voltage parameter, consequently the overall cost of the circuit or the ballast can be substantially saved.

These and other aspects of the invention will be apparent from the description of the present invention with reference to the following figures and claims.

### DESCRIPTION OF THE DRAWINGS

The present invention will now be explained, by way of example only, with reference to accompanying figures, where:

FIG. 1 is a sketch diagram of known circuit of the ignition of high intensity discharge_lamp;

FIG. 2 is a sketch diagram of ignition of the high intensity discharge lamp using the improved ignition module according to the present invention;

FIG. 3 is a sketch diagram of improved ignition module according to the present invention;

FIG. 4 is the circuit diagram of an example of igniting high intensity discharge lamp using the improved ignition module according to the present invention;

FIG. 5 is circuit diagram of another example of igniting high intensity discharge lamp using the improved ignition module according to the present invention.

In the above drawings, the same reference symbol indicates the same, similar or corresponding characteristics or functions.

### DESCRIPTION OF THE PREFERRED EMBODIMENTS

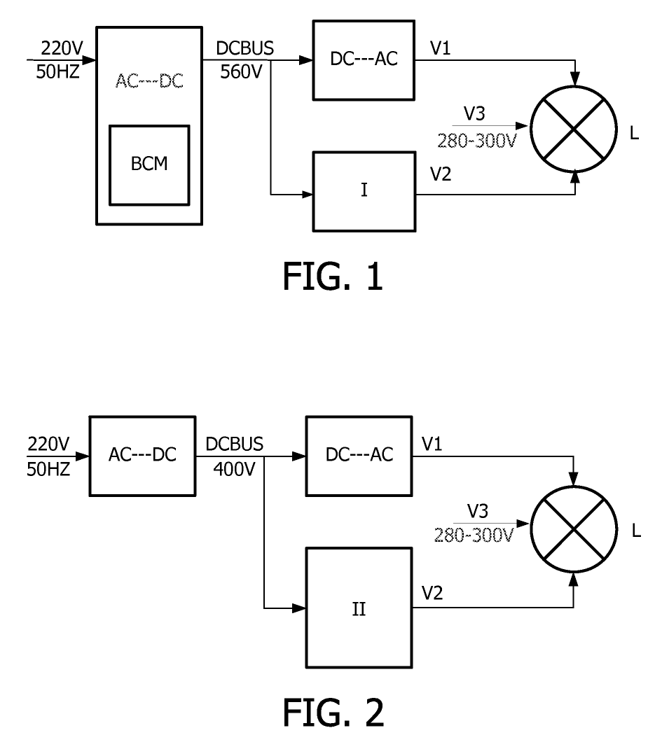

FIG. 2 is a function and structure diagram of ignition the high intensity discharge lamp according to the present invention. Comparing with the prior art as shown in FIG. 1, after adopting the improved ignition circuit, present invention can employ a lower DCBUS voltage, for example, the standard DCBUS of 400V, does not need to boost the stand DCBUS voltage. For example, after rectifying and transforming the utility power by AC-DC part so as to obtain DCBUS of 400V, the circuit can obtain a first series of alternate voltage V1 with a 200V effective value just by using a inverter circuit; meanwhile, the improved ignitor (shown as “II” in FIG. 2) can output a second series alternate voltage V2 with some effective value; finally, the OCV V3 formed at the two ends of the high discharge lamp will be obtained by superposing V1 and V2 then boosting them.

Refer to FIG. 1, although the peak value of V2 is very high, but for very low duty cycle, V2 can not substantively contribute to the final OCV. According to the present invention as shown in FIG. 2, a improved ignitor (II) is used, which can output a series of alternate voltage (V2) with improved waveform, thus the ignitor will provide a substantive contribution for OCV. In this case, boosting the DCBUS is not the only way to get a required OCV.

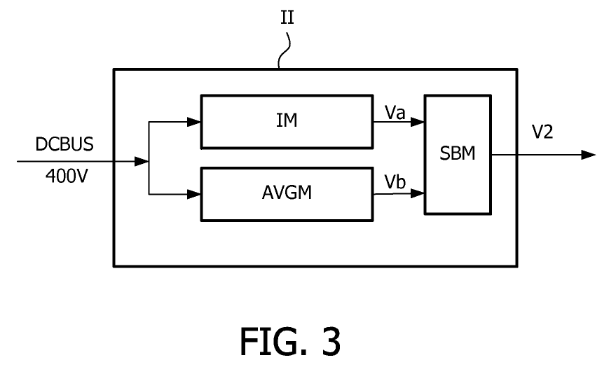

FIG. 3 is a sketch diagram of improved ignition (II) module according to the present invention. In order to get the enough contribution to increase the effective value of OCV, the output voltage wave shape need to be optimized. The ignitor is mainly composed of the power switching tube or transistor and other elements, while said power switching tube or transistor needs an external actuating signal source with a specific frequency to produce the corresponding waveform.

In order to meet the requirements of ignition the high intensity discharge lamp, the ignitor generally should generate the ignition voltage of 3.5 KV to 5 KV, and this brings forward specific requirements on the design of the circuit. If said circuit is also used for increasing the effective value contribution to the OCV at the same time, this can be realized by adjusting the parameters like frequency, pulse width, interval cycle, but after all, the above-mentioned different design purpose has different requirement on the circuit, and it is hard to attend to both of the requirements. Hence, the present invention solves said problem by adding an auxiliary circuit.

As shown in FIG. 3, besides the ignition module (IM) as known in the prior art, an additional voltage generation module (AVGM) is added within the improved ignitor (II) module. Thus in the improved ignitor (II), the ignition module IM is still used to generate the high voltage pulse ignition voltage Va, while the auxiliary circuit AVGM is used to generate an additional voltage Vb having steady waveform; and Va and Vb are superposed and boosted, then outputted as a voltage V2 having rather high effective value through a superposition and boosting module (SBM).

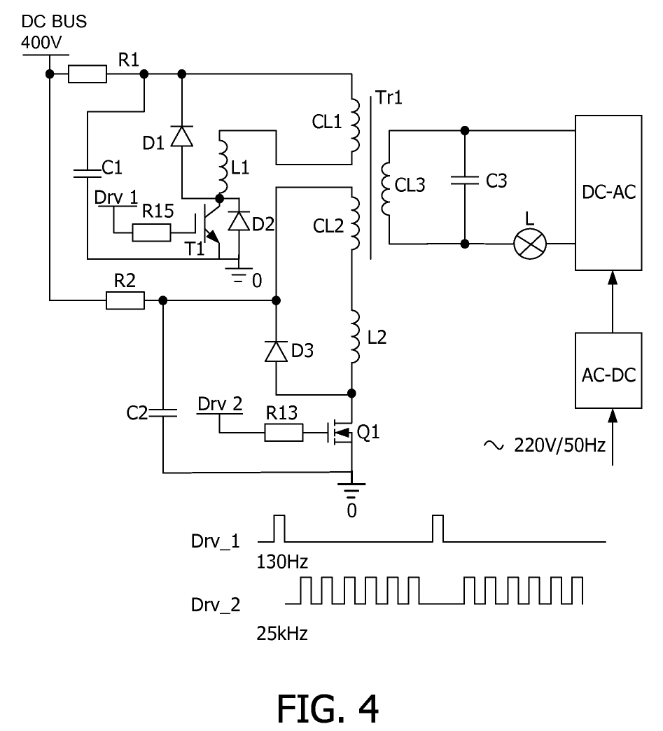

FIG. 4 is a circuit diagram of ignition the high intensity discharge lamp employing a improved ignitor (II) according to the present invention. As shown in the FIG. 3, the ignition circuit disclosed by the present invention comprises ignition module(IM), additional voltage generation module (AVGM) and superposition and boosting module (SBM). In FIG. 4, the ignition module IM comprises a current limiting resistor R1, a charge/discharge capacitor C1, a power tube T1, a current limiting inductance L1; the additional voltage generation module AVGM comprises a current limiting resistor R2, charge/discharge capacitor C2, current limiting inductance L2, and power tube Q1; superposition and boosting module SBM comprises a boost transformer Tr1, which comprises three coils CL1,CL2, CL3. Also some auxiliary units are shown in FIG. 4, for example, the diodes D1, D2, D3 are used for voltage clamping, the resistors R13 and R15 are current limiting resistors supporting for driving the power tubes, the capacitor C3 are used for keeping the oscillation and optimizing the output waveform. The Drv1 in the circuit is a low frequency signal source, such as 130 Hz, for driving power tube or transistor T1.

As shown in FIG. 4, while the power tube T1 is off, DCBUS charges the charge/discharge capacitor C1 through the current limiting resistor R1 so as to let the voltage on C1 reach the DCBUS voltage; while the power tube T1 is on, C1 discharges through the booster transformer Tr1, current limiting inductance L1, and power tube or transistor T1; meanwhile, the voltage Va formed at the first level coil CL1 can be outputted to the coupled second level coil CL3. Because of T1 is drived by Drv1 which has the very low duty cycle, DCBUS has enough time to charge C1; while T1 is on, C2 will discharge in very short time; hence, a high voltage pulse Va, with very peak value and with pulse width of several or tens of microseconds, will be formed at CL1, and also be outputted to the coupled second level coil CL3; thus a alternate pulse voltage V2 will be generated at the second level coil CL3, with about 3.5 KV-5 KV peak value and very low effective value at about several volts.

In order to increase the effective value of the output voltage V2, an auxiliary circuit AVGM is added, which is drived by high frequency signal source Drv2. While the power tube Q2 is off, DCBUS charges C2 via R2; while Q2 is on, C2 discharges via CL2, L2, Q1. Because the driving signal of Dr2 is high frequency signal, i.e. the cycle for charging and discharging is very short, thus the outputted waveform are rather steady, has the fairly high effective value instead of high peak value. Therefore, the voltage (Vb) formed at another first level coil CL2 have not the high amplitude, but have fairly high effective value.

The voltages Va and Vb generated by the above-mentioned two modules can be superposed and boosted by the superposition and boosting module (SBM) to output a combined voltage V2. As shown in FIG. 4, SBM comprises a boost transformer Tr1 that contains three coils CL1, CL2, CL3. If CL1, CL2, CL3 are also used to denote the coils number of each coil respectively, the voltage relation between the three coils should accord to below formula:

(Va+Vb)/V2=(CL1+CL2)/CL3

V2=(Va+Vb)CL3/(CL1+CL2)

By adjusting the coils number of the coils CL1, CL2, CL3, the required V2 can be adjusted correspondingly. Because of Va,Vb and V2 are alternate voltage, so their effective value may not accord to above relation. In comparison with increasing the effective value of V2 only by boosting Va, because the waveform of Vb is fairly flat, it is easier to achieve the required effective value by superposing and boosting Va and Vb.

Thus by designing the new ignition circuit, the ignition circuit can output a voltage V2 not only having high peak value such as 3.5 KV to 5 KV but also having fairly high effective value such as 50V. As introduced in FIG. 2, DCBUS can generate OCV V1 with a certain effective value such as 200V; V1 and V2 can be superposed at the two end of the lamp so as to form a required OCV, with both the high peak value and enough effective value to ensure the ignition of the gas discharge lamp.

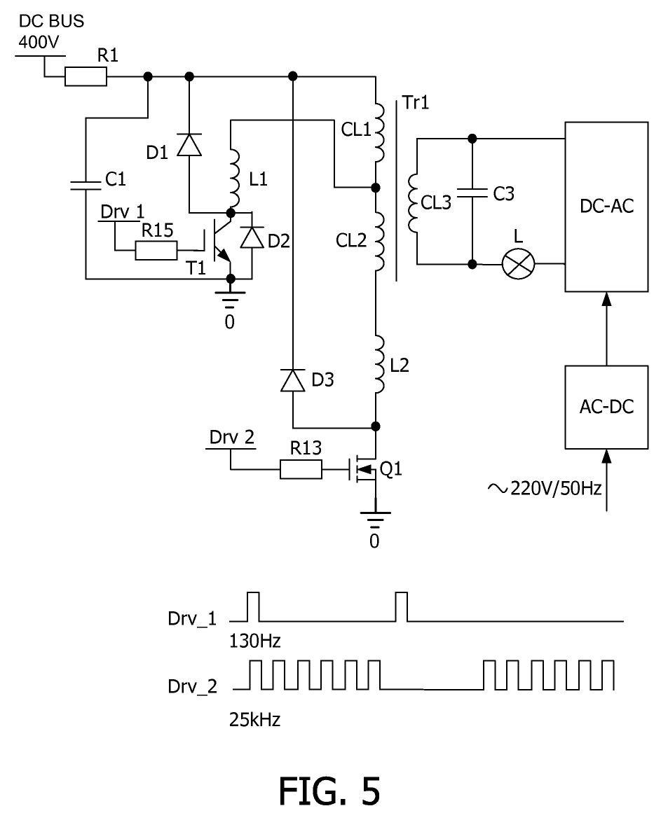

FIG. 5 is circuit diagram of example for employing the improved ignitor (II) for igniting the high intensity discharge lamp according to the present invention. The present embodiment differs from that of FIG. 4 by reducing some auxiliary elements thereby to further reduce the cost, but the working principle is the same. For example, the current limiting resistor R2 and the charge/discharge capacitor C2 is omitted; correspondingly, AVGM shares the current limiting resistor R1 and charge/discharge C2 with IM. Moreover, as shown in FIG. 5, CL1 and CL2 can be different coils of one transformer, and the CL1 and CL2 can be adjustable.

The above embodiments are described only illustratively, and are not intended to limit the scope of the present invention. Although the present invention is described in detail by referring to preferred embodiments, those skilled in the art will understand that the technique approaches of the present invention could be modified without departing from the scope of the present invention.

Use of the verb “comprise” and its conjugations not exclude the presence of elements or steps other than those stated in the claims. Use of the article “a” or “an” preceding an element or step does not exclude the presence of a plurality of such elements or steps.

1. An ignition module for a gas discharge lamp, said ignition module comprising:
a first module for generating a first series of pulse from a low frequency driving signal,
a second module for generating a second series of pulse from a high frequency driving signal,
a superposing and boosting module for superposing and boosting said first series of pulse and said second series of pulse so as to generate an output pulse intended to break down the gas in said gas discharge lamp;

2. An ignition module as claimed in claim 1, wherein said first module comprises a transistor intended to receive said low frequency driving signal for generating said first series of pulse.

3. An ignition module as claimed in claim 1, wherein said second module comprises a transistor intended to receive said high frequency driving signal for generating said second series of pulse.

4. A system for starting a gas discharge lamp, said system comprising:
a rectifier for transforming an AC mains voltage into a DC voltage (DCBUS),
an inverter for transforming said DC voltage into a first AC voltage (V1) intended to provide energy to said gas discharge lamp,
a first module for generating a first series of pulse from a low frequency driving signal,
a second module for generating a second series of pulse (Vb) from a high frequency driving signal,
a superposing and boosting module for superposing and boosting said first series of pulse and said second series of pulse so as to generate an output pulse intended to break down the gas in the gas discharge lamp.

5. A ballast for a gas discharge lamp comprising an ignition module as claimed in claim 1.

6. A method for igniting a gas discharge lamp, said method comprising the steps of:
generating a first series of pulse from a low frequency driving signal,
generating a second series of pulse from a high frequency driving signal,
superposing and boosting said first series of pulse and said second series of pulse so as to generate an output pulse intended to break down the gas in said gas discharge lamp.
